(19) United States
(12) Patent Application Publication
(10) Pub. No.: US 2012/0240039 A1
(43) Pub. Date: Sep. 20, 2012

(54) SYSTEMS AND METHODS FOR FACILITATING TRANSLATION OF DOCUMENTS

(75) Inventors: Jay S. Walker, Ridgefield, CT (US); Zachary T. Smith, Norwalk, CT (US); Evan R. Walker, White Plains, NY (US)

(73) Assignee: WALKER DIGITAL, LLC, Stamford, CT (US)

(21) Appl. No.: 13/421,811

(22) Filed: Mar. 15, 2012

Related U.S. Application Data
(60) Provisional application No. 61/453,122, filed on Mar. 15, 2011.

(51) Int. Cl. G06F 17/20; G06F 17/28

(52) U.S. Cl. 715/265; 704/2

(57) ABSTRACT

In accordance with some embodiments, processes and systems are provided for facilitating mass translations of documents by translators (e.g., freelance translators) via an online system which provides an interface for facilitating such translation. In accordance with one embodiments, the processes and systems provide for receiving an original document which includes both text and non-text (e.g., images, graphs, charts) components, extracting the text from the document, presenting the extracted text to a translator, receiving a translated text of the text and creating a translated version of the original document based on the received translated text and a layout of the original document, such that the aesthetic characteristics of the original document are generally preserved without the translator's efforts being distracted to such aesthetic characteristics and layout.

### CROSS-REFERENCE TO RELATED APPLICATIONS

The present application claims the benefit of U.S. Provisional Application No. 61/453,122, entitled SYSTEMS AND METHODS FOR FACILITATING TRANSLATION OF PUBLICATIONS and filed Mar. 15, 2011 in the name of Walker et al. The entirety of this Provisional Application is incorporated by reference herein for all purposes.

### BRIEF DESCRIPTION OF THE FIGURES

The foregoing and other features, aspects and advantages of the invention are described in detail below with reference to the drawings of various embodiments, which are intended to illustrate and not to limit the invention. The drawings comprise the following figures in which:

FIG. 1 is a block diagram of one example system in accordance with some embodiments described herein.

FIG. 2 is a block diagram of another example system in accordance with some embodiments described herein.

FIG. 3 is a flowchart of one example method consistent with some embodiments described herein.

FIG. 4 is a flowchart of another example method consistent with some embodiments described herein.

FIG. 5 is a flowchart of another example method consistent with some embodiments described herein.

FIG. 6 is a flowchart of yet another example method consistent with some embodiments described herein.

FIG. 7 is an example of an interface consisting of a plurality of elements, which may be output to a Translator in accordance with some embodiments described herein.

### DETAILED DESCRIPTION OF THE FIGURES

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and it is possible that no single feature is solely responsible for its desirable attributes or is essential to practicing the inventions herein described.

In accordance with some embodiments, provided herein are systems, methods and platforms which allow publishers of publications (e.g., publishers of medical journal publications) and/or authors of such publications to submit such publications to be translated from a first language to one or more second languages and made available (in the translated form) for sale or distribution in one or more jurisdictions. One benefit of at least some of the embodiments is, without limitation, that it allows publishers and/or authors to tap into a latent revenue stream by enabling vetted, freelance translators (or translators employed by a service which provides such translation services) to translate content from the original language into one or more languages without needing to retain, vet, review or compensate a translator directly but rather rely on the translation service described herein to do so. In one embodiment, the described service makes this translated content available for purchase or distribution on platforms available in one or more jurisdictions and splits the sales revenue between at least the original publisher and the translator (or the service which employs or retains the translator) or otherwise provides compensation to the publisher for utilizing the service. The publisher, in turn, may provide some compensation to the author of the original work based on revenue received as a result of the sale or distribution of the translation (or, in some embodiments, the translation service may provide such compensation to the author directly). In one embodiment, ownership of the copyright in the translated work may also be shared between the original publisher of the work (in the original language) and one or more of (i) the author of the original work; (ii) the translator or (iii) the translation service.

In accordance with one or more embodiments, the work or content to be translated is referred to as a document. A “document” as the term is used herein, refers to any collection of data capable of being rendered on a tangible medium (e.g., paper or electronically such as on a web page), such as a WORD, EXCEL or PDF file, or an image file. The term “document” as used herein, unless indicated otherwise, refers to content or data associated as a single instance for which translation is requested. For example, in one embodiment a book may be a document composed of many pages or sections, but the entirety of the book may be considered a single document. In another embodiment, a first chapter or page of a book may be considered a first document while a second chapter or page of a book may be considered a second document. A document may comprise, for example, text, symbols, mathematical equations, chemical formulas, images, drawings and/or embedded objects. A document may be in any format, language or medium.

A document may include, for example, text as well as one or more of an image, a graph, a chart, a window to external content (e.g., a window to a video), an equation or a formula. A document may include different areas. For example, one area of a document may include a paragraph of text, another area of a document may include an image, another area of the document may include text comprising a caption for the image and yet another area of the document may include a heading for a column or paragraph of the document. In some embodiments, a document may correspond to certain particular layout that comprises a set of characteristics and choices which together provide a specific aesthetic appearance to the content of the document. Examples of characteristics which may contribute to a particular layout include, without limitation, a page layout (e.g., 2 column layout, horizontal vs. vertical page orientation), font size, font style, font color, line spacing and background fill. In some embodiments, each area of a document may be associated with a particular set of characteristics and a particular layout of the document may consist of the totality of the areas as they are positioned relative to one another and the respective set of characteristics of each area.

In accordance with some embodiments, a document received for translation may be segmented into parts, such that each part may be presented to a translator (a term more fully described below) for translation independent of the other parts or out of a context of the document in its entirety. In some embodiments, the different parts of the same document may be translated by two or more different translators working independently form one another and/or may be translated at different times (e.g., not in a contiguous timeline). In some embodiments, the parts of the document may not be translated independently, in that the same translator may be made aware that the parts are each associated with a single document. For example, the particular part of a document for which translation is requested may be presented to a Translator along with the document as a whole. This may be advantageous in that it may allow or motivate a Translator to use consistent terminology within the same document for the same concepts, terms, words or clauses. In some embodiments, the part of the document for which translation is being requested in a particular instance or transaction may be presented in a first interface or element of a web page (e.g., a first window or pane of the page) while the document as a whole may be presented in a second instance or element of a web page (e.g., in a first window or pane of the page or as a PDF available for download by the translator).

In accordance with some embodiments, one or more entities (which may comprise persons, businesses, organizations or groups of any of the foregoing) may be referred to in describing particular systems and method herein. Some example entities used in the present description are explained as follows.

A “publisher,” as the term is used herein unless indicated otherwise, may comprise an entity who published the content or work in an original language and who may have some ownership rights (e.g., some copyright rights) in the content as originally published; in some embodiments a Publisher may comprise an author of the content in at least the original language, medium, form or format.

A “translator,” as the term is used herein unless indicated otherwise, may comprise consultant or employee of a translation service who translate the original content from a first language into a second language, from a first medium to a second medium and/or from a first form or format to a second form or format (e.g., translate the content from a first computer language to a second computer language).

A “certifier,” as the term is used herein unless indicated otherwise, may comprise a translator with the responsibility of reviewing, verifying the accuracy of, approving and/or certifying a translated work or the quality of a translated work.

A “proctor,” as the term is used herein unless indicated otherwise, may comprise a bilingual consultant or employee of a translation service who reviews translator tests and assigns translator levels, ratings or other indicators of a translator's abilities to translate.

A “distributor,” as the term is used herein unless indicated otherwise, may comprise an online platform where e-publications are sold or otherwise distributed. It should also be noted that the term “e-publication” refers to a document that can be purchased in an electronic format. Examples of e-publication formats include, but are not limited to, .doc; .epub; .pdf; .doc; .docx; .txt; .psd; etc. E-publications may be viewed using specialized software on a computing device designed to open e-publication formats.

An “admin,” as the term is used herein unless indicated otherwise, may comprise an employee of a translation service who is tasked with handling system glitches and managing customer service issues.

A “translation service,” as the term is used herein unless indicated otherwise, may comprise a service which accepts works for translation, provides an appropriate translator and facilitates (i) the translation of the work (e.g., by verifying or certifying the accuracy of the translation) from a first language to a second language, (ii) the fees and payments to various appropriate entities for such translation and/or (iii) the sale and/or distribution of the translated work.

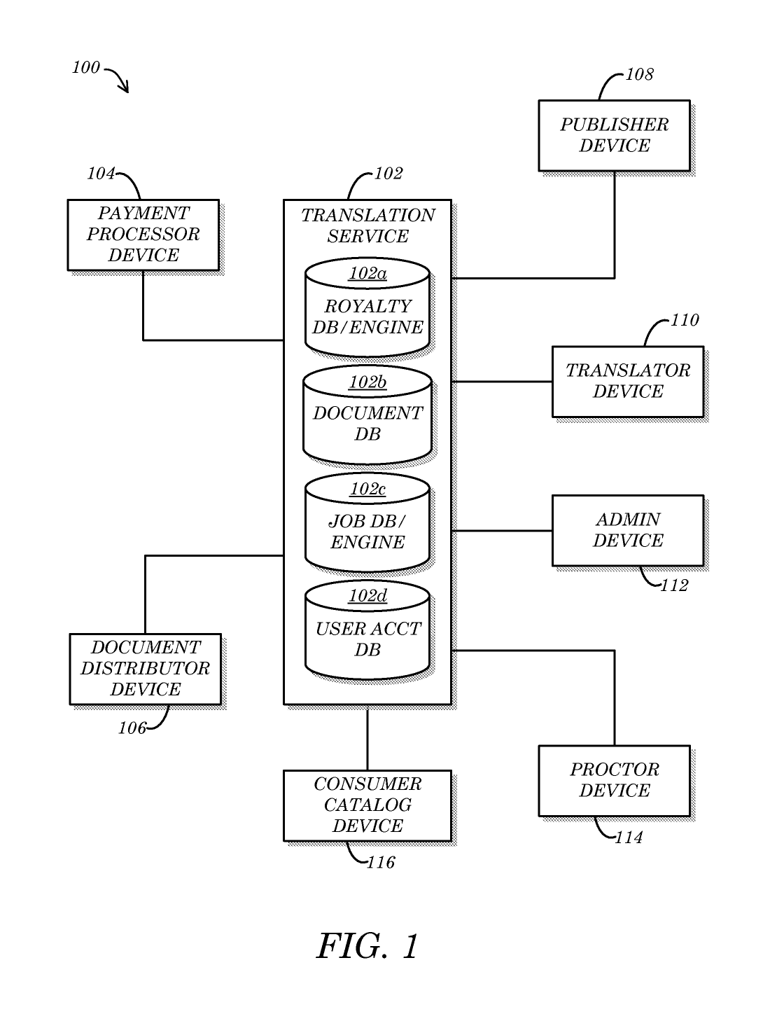

Referring now to FIG. 1, illustrated therein is a block diagram of one example system 100 which may be operable to facilitate some of the methods and functionalities described herein. The system 100 comprises a translation service server 102, a payment processor device 104, a document distributor device 106, a publisher site device 108, a translator site device 110, an admin site device 112, a proctor site device 114, and a consumer catalog site device 116. In some embodiments, any of the devices of system 100 (including translation service server 102) may each be operable to communicate with at least one other device of system 100 via one or more networks. The one or more networks may comprise, for example, the Internet, a wide area network, another network or a combination of such networks. It should be understood that although not shown in FIG. 1, other networks and devices may be in communication with any of the devices of system 100. For example, translation service server 102 may be in communication with a mobile network (not shown) such as a pager or cellular telephone network that accommodates wireless communication with mobile devices as is generally known to those skilled in the art.

The any or all of the translation service server 102 and the devices 104 through 116 may comprise, respectively, one or more computing devices, working in parallel or series if more than one, operable to facilitate the methodologies and functions described herein for supporting a translation service for documents. It should be noted that in some alternate embodiments, any or all of the devices 104 through 116 may comprise translation service server 102. Accordingly, any or all of the functions described herein as being carried out by any of the devices 104 through 116 may in alternate embodiments be carried out by translation service server 102.

Translation service server 102 comprises a plurality of modules and databases for facilitating the translation of documents as described herein, including (i) a royalty engine and/or royalty database 102a, (ii) a document database 102b, (iii) a job engine and/or job database 102c, and (iv) a user account database 102d. Each of these is described in more detail below. Additional engines and/or database may be used and the data and/or functionality described herein as being stored in a particular database or software module may, in other embodiments, reside in or be combined with a different database and/or module.

A royalty engine/database 102a may, for example, function to facilitate (i) the management, tracking, distribution and/or apportionment of royalties for translated documents; (ii) revenue collection; and/or (iii) copyright ownership or other rights tracking and/or management. In accordance with one or more embodiments, a program or process of the translation service such as the royalty engine/database 102a may facilitate royalty or other compensation management handled by the translation service (e.g., royalties or other compensation provided to a translator or certifier in exchange for translating or certifying documents received for translation). The following are some examples of subroutines and management practices that may be implemented by the translation service.

In accordance with some embodiments, when a translator accepts a job or is assigned or approved for a job, he or she also agrees to be paid in accordance with the payment specifications chosen by the publisher who has requested the translation of the document comprising the job. For example, as described herein, in some embodiments a publisher can choose to pay for a translation via an upfront, one-time payment or via downstream royalty payments. The following description of example functionalities of a royalty engine/database 102a only applies to payment situations in which royalties are involved.

In accordance with some embodiments, when a translator claims a job (or is assigned or approved for a job) that uses royalty payments, (s)he agrees to be paid via a standard royalty schedule corresponding to the job. In one example royalty schedule, the system tracks the amount of revenue that is due to the translator based on a stored set of royalty rights corresponding to the translated document of a job. The royalty schedules may structured in one of the following example ways:
(i) Three way split between the publisher, the translator, and the translation service (e.g., 35/35/30);
(ii) Four way split between the publisher, translator, certifier, and the translation service (e.g., 25/10/35/30)

In accordance with some embodiments, while the % split may be standard, the royalty schedule may be further broken down into two stages, which are separated by a varying threshold amount of copies of the translated document which are sold or which otherwise generate revenue. In other words, the revenue collected up to the threshold will be split A %-B %-C %, and after the threshold it is split X %-Y %-Z %. In some embodiments, the threshold amount may vary by document, and may be selected automatically based on the word count of the original.

In accordance with some embodiments, information about the amount of revenue each translated document has accrued may be collected from the document distributor (in embodiments in which the system does not sell the translated documents directly). This revenue may then be split up, based on the assignment of royalty rights.

In accordance with some embodiments, once the revenue is split, and the revenue divided, the appropriate user account balance may be updated. Thus, in some embodiments the royalty engine/database 102a may be operable to communicate or update the user account database 102d.

In accordance with some embodiments, payment schedules may be tied directly to the method of payment used by the system (e.g., if electronic, it may be paid out whenever the account user triggers a payment; if physical check, the system may cut and mail checks according to a schedule or threshold).

A document database 102b may, for example, function to facilitate the storing and management of original documents, translated documents and modified translated documents (e.g., documents which were translated by a translator and subsequently modified by a certifier), including status, layouts and characteristics thereof. The following are some examples of subroutines and management practices that may be implemented by the translation service, which subroutines and practices may utilize the document database 102b.

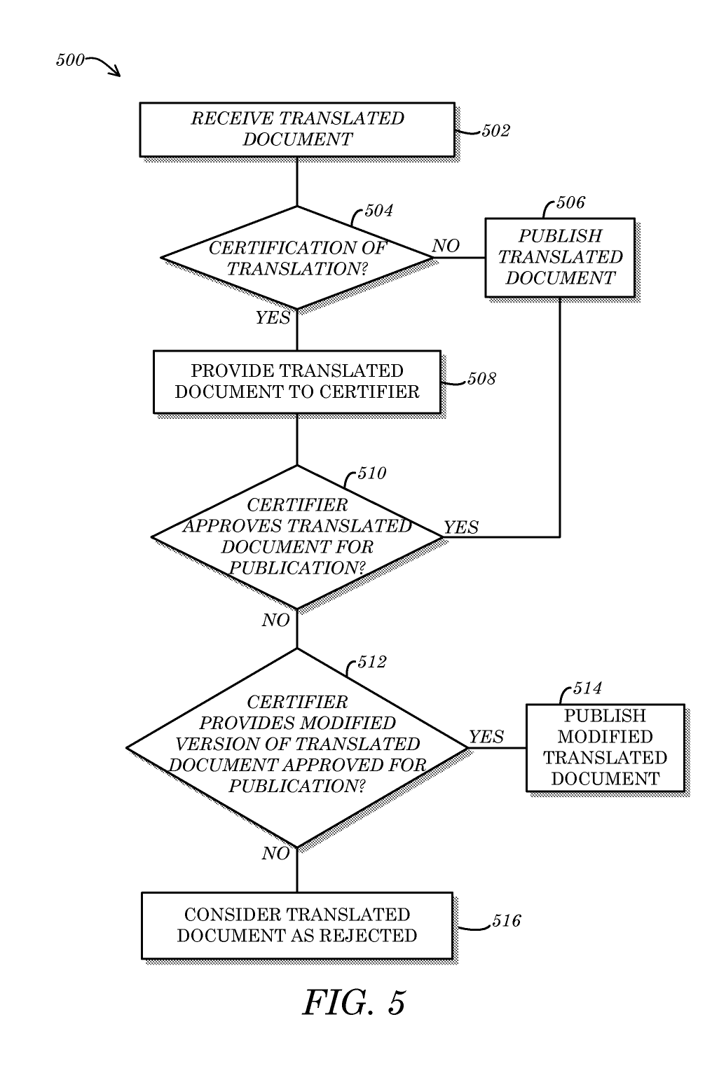

In accordance with some embodiments, documents that are uploaded to the system by a publisher for translation may be stored in a database in association with a new job. For example, the job engine 102c may assign a unique job identifier to a job, which job identifier is stored in document database 102b in association with the document for which translation is requested. It should be noted that more than one job or job identifier may be associated with a given document. Such documents may subsequently be retrieved for prepping by the job engine (e.g, in accordance with the process 500 of FIG. 5) and/or when an associated job is claimed or assigned so that it can be downloaded and/or viewed by the translator claiming the job.

In accordance with some embodiments, documents that are uploaded to the system by a translator (or by a certifier) may be stored in the document database 102b in association with the original document. For example, a unique identifier may be assigned to the original document when it is stored in the system and another unique identifier may be assigned to the translated document when it is stored in the system, and the two identifiers may be associated with one another in the document database 102b and/or the job database 102c.

In accordance with some embodiments, access to documents may be managed by the system based on a characteristic of an entity using the system. An example of one permission scheme for such management rules comprises: (i) admins can see all documents; (ii) publishers can see all documents related to a job they've posted; (iii) translators and certifiers can only download a document when a job has been claimed or assigned; (iv) proctors are provided no access to documents; and (v) consumers are provided no access (consumers obtain access to documents via a distributor or catalog website).

A job engine and/or database 102c may, for example, function to facilitate (i) storing jobs received for translation (including specifics associated therewith); (ii) posting new jobs to jobs board; (iii) deleting jobs from a jobs board; (iv) tracking and managing the progress of jobs; and/or (v) managing access to jobs. In accordance with some embodiments, when a publisher submits a document for translation, a new job is created (e.g., by the job engine 102c) in the system. This job may be stored in the system (e.g., in a job database 102c) and appear on the job board for qualified translators. In some embodiments, a job may first be reviewed, filtered and/or approved in some manner prior to being posted on the job board by job engine 102c. In some embodiments, job postings may be created (e.g., by job engine 102c) when a document is initially uploaded to the system for translation and when a newly translated document is uploaded (e.g., if the newly translated document requires certification). In some embodiments, multiple “job postings” may be created upon the uploading of a single document. For example, while in some embodiments a separate job board is maintained for each available language, in other embodiments one main job board may be maintained but filtered based on the translator's language. If all job listings and/or summaries in every language use the same template, then the job engine 102c may be operable to display the job on a job board in appropriate languages as requested in the job specifications. However, if there is a unique listing/posting created for every job board language, then multiple postings may need to be generated for a single document.

In accordance with some embodiments, the job board may be operable to support multiple job priorities and job types; thus, in some embodiments it may be desirable to manage (e.g., by the job engine 102c) the priority of jobs intelligently so that high priority jobs are likely to be fulfilled in an expeditious manner. Some example of the types of jobs that may be available on a job board include: (i) translation jobs (e.g., which may be created by job engine 102c for every document uploaded by a publisher with a request that it be translated); (ii) certification jobs (e.g., which may be created by ob engine 102c for every submitted translated document that has been translated by a translator and that requires certification); (iii) grading jobs (e.g., which may be created by job engine 102c for proctors (in some embodiments, rather than seeing a list of available grading jobs, proctors logging in to the system may only be presented with the first available grading job, as managed by the translation service)).

In accordance with some embodiments described herein, a job board engine 102c may be operable to manage the job board based on the job specifications provided by the publisher. For example, if a publisher specified that he does NOT want a Spanish translation, then the job may not be posted on a job board of jobs available for translation into Spanish.

In accordance with some embodiments, a job engine and/or job database 102c may support searching and filter which allow a user to search for or be automatically presented only with jobs which meet certain specified criteria. For example, in some embodiments when a translator logs in to a job board, (s)he will only be presented with jobs that (s)he is qualified to perform (e.g., based on information associated with the translator, which may be determined based on the translator's login information). Therefore, two different translators may see the job board very differently based on both the job specifications of available jobs and which of the jobs (based on the job specifications) are satisfied by information associated with the translator (e.g., language the translator is certified in, translator proficiency level, specialties, etc.). The following are some examples of additional criteria which may be used to filter which jobs may be shown to a particular translator: (i) certifier status (e.g., review jobs are only made available to certifiers); and (ii) posting date of a job (e.g., the system may order the jobs by default so that older jobs are listed first). In some embodiments, jobs posted more than a predetermined period of time from a current time will be removed from the job board and/or the associated publisher may be contacted to review and potentially modify the job specifications to expand the pool of qualified translators or certifiers for the job.

In accordance with some embodiments, a job board will be searchable and the job engine and/or job database 102c may be operable to present a set of search results when a user is searching for a job. Examples of criteria or fields by which jobs may be searched include: (i) a title of a document; (ii) an author of a document; (iii) a publisher of a document; (iv) a specialty requirement for a translator or certifier; (v) text of a document, abstract or summary of the document.

In accordance with some embodiments, a job engine 102c may be operable to remove a job from a job board or otherwise render it unavailable for claiming by translators, certifiers or proctors (e.g., once a job has been claimed by a translator, the job may be removed from the job board). In some embodiments, the system may support more than one translator to take or participate in translating a particular document (in which case the document may be divided up into multiple jobs, each job corresponding to a different part of the document) or in a particular job. Thus, a job may be divided up among multiple translators and/or translators may compete (e.g., bid) for a job. In yet other embodiments, if more than one translator is interested in a job, the translation service may allow each interested translator to indicate interest and may then facilitate a selection from among the interested translators (e.g., based on translator rating, level, ability, frequency of doing jobs for the translation service, the last time each translator did a job, the average or typical length of time the translator take to do a job, a publisher preference or otherwise).

In accordance with some embodiments, the job engine 102c may be operable to repost a job on a job board. For example, if a translated document has been rejected by certifier, the job may need to be reposted to a job board (and, in some embodiments, potentially prioritized higher than one or more other jobs). In accordance with some embodiments, there may be some predetermined period of time delay between the rejection and the reposting so that that the translator has a chance to appeal the rejection.

A user account database 102d may, for example, function to store information on the various users and types of users (including credentials for various levels of access, qualifications and status) involved with the translation service (e.g., translators, proctors, admins, consumers, publishers and certifiers). In accordance with one or more embodiments, a program or process of the translation service may facilitate account or entity management associated with the translation service. The following are some examples of subroutines and account/entity management practices that may be implemented by the translation service (e.g., by use of the user account database 102d).

In accordance with some embodiments, translations can be rated by consumers (persons purchasing or accessing the translated documents), which ratings may be associated with the translator's account as well. In some embodiments, as described herein, the system may be operable to provide aggregated ratings information for each translator.

In accordance with some embodiments, each time a translator's work is rejected, the rejection is recorded by the system. In accordance with some embodiments, the system will track rejections for use in some decisions. For example, the following decisions may be impacted by one or more tracked rejections of a particular translator's work: (i) suspension or expulsion from the system; (ii) determining whether to assign a particular job to the translator; (iii) determining whether to require a translator to retake a test; (iv) determining a proficiency level of the translator; and/or (v) determining compensation to be provided to a translator.

In accordance with some embodiments, the system can store and update inputted profile information for each user in a user account database 102d. Such profile information may be updated by the system based on events involving the user and/or by the user directly. For example, as described above, in accordance with some embodiments, each new test results in an updated set of qualifications for the associated translator as well as new rights or privileges regarding a job board. In addition, each user having an account with the translation server may have different levels of access to a variety of information or data within the system, as described elsewhere herein.

Various devices 104 through 116 are illustrated in FIG. 1 as being purposed for particular functions and to support various sites, interfaces or portals with which the translation service may interact or interface, and which may be involved in receiving information from and/or providing information to the translation service server 102. It should be noted that, in some embodiments, one or more of these “sites” supported by the respective devices 104 through 116 may in fact by web pages or web sites affiliated with, directed or operated by or operated on behalf of the translation service and/or translation service server 102. In other embodiments, one or more of the sites supported by the respective devices 104 through 116 may be operated by third parties which are independent of the translation service (but which, in some embodiments, enter into a contract or other agreement with the translation service to provide certain supporting functionality to the translation service).

The payment processor device 104 may, for example, be operated a third party payment processing service such as one operated by a credit card network, company or organization or an alternate payment mechanism such as PAYPAL™. The payment processor device 104 may function, for example, to approve, verify and/or process payments to and/or from the translation service (e.g., payments from consumers for access to translated documents, payments from publishers for translation jobs, payments to translators and/or certifiers for performed jobs, etc.).

The document distributor device 106 may, for example, be operated by a third party content provider service such as AMAZON.COM™, iTUNES™. The document distributor device 106 may function, for example, to provide access to consumers of translated documents. The publisher device 108 may, for example, comprise a device of a publisher (e.g., a computer of an author, a server of an organization or company which publishes a document in an original language).

In accordance with some embodiments, the translation service may not actually sell translated documents, and instead will rely upon established online document distribution platforms. On such embodiments, the translation service may limited functionality to distribute documents and may rely on communications with the document distributor via a document distribute device in order to make distributed documents available to consumers.

The distributor may receive the translated documents provided by the translator service and post them for sale or other access (e.g., paid subscription access) in their platform. Therefore, any requirements the distributor has on their end may drive some functionality of the translation service related to providing a translated document for sale or other access. In some embodiments, a distributor may offer an API which may enable the translation service to automate the submission in bulk of newly translated documents for sale or other access. In some embodiments, a distributor may require a document format different than the format a translated document is currently in; in such embodiments the translation service may be operable to convert documents to the appropriate format before passing them on to the distributor.

In accordance with some embodiments, the distributor may be responsible for completing a transaction with customers purchasing a translated document provided to the distributor by the translation service. In other embodiments, the translation service or a third party entity may facilitate such a purchase. In accordance with some embodiments, the translation service may be operable to receive information from the distributor about sales so that it can calculate how to distribute royalties. In accordance with some embodiments, the translation service may receive revenue from the distributor based on the sales of the translated document sold by the distributor. This may be in the form of electronic payment, a check payment or another form of payment.

The publisher device 108 may function, for example, to transmit an original document, a job summary, specify a royalty scheme for a job, register a publisher and/or allow a publisher to view, select and/or specify profile information for a translator. In accordance with some embodiments, a publisher device 108 may allow a publisher to perform various functions relative to the translation service server 102.

For example, publishers using the system 100 may be able to able to set up an account, upload documents and collect royalty or other payments for translated documents. A purpose of these accounts may be to enable the creation of new “translation jobs” which will be posted to a job board (described in more detail below). For example, a publisher using a publisher device 108 may be able to register or create an account. The account may, in some embodiments, be in the name of the publisher's employee who registers the account and (s)he may be asked to declare to the translation service which publisher he represents (or if he is a self-publisher). In one embodiment, an account setup may be performed by sales representatives of the translation service who build relationships with publishers. In such a circumstance, one account may be set up per publisher and publishers may use the same login credentials. Exemplary fields for registering or setting up a publisher account may include, without limitation, (i) an employee name; (ii) an e-mail address; (iii) a password; (iv) a Publisher name or other identifier (or name or identifier of an author in case of self-publishing); and (v) a postal mailing address. In some embodiments, publishers may be asked to agree to certain terms and conditions when registering an account. In some embodiments, the translation service may send an e-mail with a verification link (e.g., the link may need to be clicked before the account is officially accessed and/or the registrant may be asked to log in after e-mail address verification). Following are some examples of some Account Tools that may be provided to a Publisher Using the Translation Service, in accordance with one or more embodiments. For example, when a Publisher logs in to his account, he may have various tools at his disposal, including the review of his royalties and editing his account information.

The publisher device 108 may also function to allow a publisher to (i) watch a tutorial video explaining how to use the job management system and the royalty payment system; (ii) view a royalty history to determine how translated documents of the publisher are selling and how much revenue is being collected from the royalties; (iii) collect royalties for translated documents (e.g., if the publisher has direct deposit set up as his payment option, he can ask the system to pay the royalties currently due to him); (iv) edit the account information (e.g., payment information, contact information, and account password); and/or (v) close the publisher's account with the translation service system (e.g., upon a request to close an account, a payment to the publisher of all royalties or other payments due may be queued and/or all original and translated documents of the publisher may be removed from the system).

Another example of a use of a publisher device 108 is the determination or setting up of a royalty payment scheme between the publisher and the translation service. In accordance with some embodiments, publishers will earn royalty payments through the translation service based on the sales of their translated documents that the translation service publishes, distributes, sells or makes available for sale or access. Royalty payments may vary depending on the price of the work, labor, and other issues that will be described throughout this document. For example, publishers may be allowed to choose to be paid either via check, direct deposit or another appropriate payment mechanism.

The translator device 110 may comprise, for example, a computing device operable to connect to the translation service server 102 (e.g., via the Internet) and download, receive or otherwise access documents or portions thereof for translation. In some embodiments the translator device 110 may comprise a desktop computer, a mobile or portable computing device such as a smartphone (e.g., the IPHONE manufactured by APPLE, the BLACKBERRY manufactured by RESEARCH IN MOTION, the PRE manufactured by PALM or the DROID manufactured by MOTOROLA), a Personal Digital Assistant (PDA), tablet, cellular telephone or laptop or other computing device. The translator device 110 may be configured to allow a translator and/or Certifier to perform one or more of the following functions: (i) register a user as a Translator of the translation service; (ii) participate in a test as to the user's proficiency in one or more languages or specialties; (iii) view a profile of another user, such as another Translator, a Certifier or a Publisher; (iv) browse and/or select available jobs; (v) receive royalty payments or information about royalty payments; (vi) submit or enter translated text or documents; and (vi) certify translated documents.

In accordance with some embodiments, the translation service may employ or have contracts or other agreements with independent/freelance translators registered to perform translations for publishers. In accordance with one embodiment, translators who register with the system may be required to participate and complete certain tests or questionnaires which will enable the translation service to create, manage and staff translation jobs posted to a job board. The following are examples of some types of uses or functionalities which a translator device 110 may facilitate.

In accordance with some embodiments, any prospective translator (applicant) who desires to provide services to the translation service may need to first create an account. Information needed from the prospective Translator may include: (i) full name; (ii) home address; (iii) e-mail address; (iv) telephone number; (vii) user or account identifier (which may be assigned by the system in some embodiments); (viii) password; and (ix) age verification (in some embodiments, the applicant must 18 years old or older). In some embodiments, an applicant may also be required to agree to certain terms and conditions when registering. The translation service may send an e-mail with a verification link. The link may need to be clicked before the account is officially accessed

In some embodiments, an applicant may need to provide some profile information, such as one or more of the following: (i) spoken languages (e.g., may include native languages); (ii) education; (iii) if college graduate, major; (iv) if graduate student, concentration; (v) profession; and (vi) any specialized certifications or accreditations.

Once an applicant is accepted as a translator with the translation service (or when applying to become one), (s)he may be asked to provide the translation service with payment information, such as one or more of the following: (i) preferred form of payment (e.g., check, deposit to account, etc.); (ii) billing address (if different than home address); (iii) bank account routing number; (iv) PAYPAL or other online payment mechanism information.

In accordance with some embodiments, in order to become a translator, an applicant will need to pass a language test for each language in which (s)he would like to be a translator. If the applicant passes the language test, (s)he will become a translator and will be able to start working on jobs that correspond to his translating abilities. In addition, the translation service may enable a translator to acquire credentials in a specialty. Both test types may be delivered in essentially the same format, and examples of each are discussed separately below.

An applicant/translator may be able to take a language test to verify or prove his proficiency in a particular language and be allowed to translate a document from that language or into that language. The following may be needed in starting and finishing the certification of an applicant's language translating abilities for a given language. To begin the testing process, the applicant/translator may select which language, other than English, he can fluently read and comprehend. It should be noted that while English may be the base language that translators will use as a basis to prove their reading comprehension of other languages, other base languages may be used as well. Some example features of a language test include, without limitation: (i) the test may be timed; (ii) the test may be performed online; (iii) the test may be performed offline and submitted to the system when finished; (iv) an applicant may be required to translate from Language A into Language B; (v) the test may consist of a series of passages of text which the applicant will be asked to translate, each passage progressively harder than the next (e.g., level 1, 2, 3); (vi) when finished, or time runs out, the test is submitted by the applicant. In some embodiments involving a timed test, if time runs out, the applicant may no longer be able to type in the fields but he will still have to manually press submit to submit the test for grading.

In some embodiments, a proctor will grade a language test submitted by an applicant/translator and submit a score to the system. In other embodiments the language test may be graded automatically by an appropriately programmed computing device. In some embodiments the test may be graded on a Pass/Fail basis. In other embodiments the test may be graded on a sliding scale. For example, a score of 0 may indicate a failure of the test and that the applicant/translator cannot sufficiently translate a document in the given language; a score of 1 may indicate that the applicant/translator should be assigned a Level 1 translator status or skill level for a given language; a score of 2 may indicate that the applicant/translator should be assigned a Level 2 translator status or skill level of given language; and so on (in which scoring scheme a higher score corresponds to a better level of proficiency). In some embodiments, the test result may be emailed or otherwise provided to the applicant. For example, a link may be included in an e-mail, which takes the applicant to his account in which the test results are indicated.

If an applicant passes the language test, the translation service may now allow him to take jobs that involve him translating a document from or into the given language. A passing, passing score or proficiency level for the specialty test may be stored as a credential in the translator's account or otherwise associated with the translator. In accordance with some embodiments, after becoming a translator, a translator can take the language test again, both in a language he has already passed if he wants to improve his translator level, or in a new language so he can start translating documents into or from that language as well.

In accordance with some embodiments, a translator is able to take a specialty test to prove his knowledge of a specific subject in order for the translation service to allow that translator to work on jobs that require this special knowledge. The following are examples of concepts that may be relevant in providing a specialty test to a translator, in accordance with some embodiments, and in starting and finishing the certification of a Translator's language translating abilities for a specific language: (i) the language in which a translator is already certified in and in which (s)he will take the specialty test in; (ii) the specific specialty in which the translator desired to be tested. Example features of a specialty test include, without limitation: (i) the specialty test may be timed; (ii) the specialty test may be taken online; (iii) the specialty test may be taken offline and submitted to the system when finished; (iv) the specialty test may focus on particular vocabulary related to the specialty being tested; (v) the specialty test may be asked to review a passage in Language A and translate it into Language B and also to review a passage in Language B and translate it into Language A. When finished, or time runs out, the test is submitted by the applicant. In a timed test embodiment, if time runs out, the applicant may no longer be able to type in the fields but he will still have to manually press submit to submit the test for grading.

In accordance with some embodiments, a proctor certified in the specialty being tested may grade the test and submit a score to the system. In other embodiments, the test may be graded automatically be an appropriately programmed computing device. In some embodiments the test may be graded on a Pass/Fail basis. In other embodiments the specialty test, as described with respect to the language test, may be graded on a sliding scale (e.g., a score of 0 indicates a failure of the test; a score of 1 indicates the translator should be accorded a Level 1 translator status of given specialty; a score of 2 indicates the translator should be accorded a Level 2 translator status of given specialty, etc., in which scoring scheme a higher score corresponds to a better level of proficiency). As with the language test, the test result of a specialty test may be emailed or otherwise provided to the applicant/translator and if the applicant/translator passes the specialty test, the system may subsequently allow him to take jobs that require knowledge of that specialty. A passing, passing score or proficiency level for the specialty test may be stored as a credential in the translator's account or otherwise associated with the translator. It should be noted that a translator may be allowed to take multiple specialty tests across any of the languages he has been certified in.

Thus, to summarize, a translator device 110 may facilitate various functionalities made available to a translator, many of which may be accessible to the translator once (s)he registers or opens an account with the translation service. A database of translator accounts may be stored, for example, in translation service server 102 and accessed remotely by a translator logging in via a translator device 110. In accordance with some embodiments, a translator's account will allow a translator to access various tools to allow him/her to, for example, manage his royalties, take tests, and control his profile. The following are some examples of such tools. In some embodiments, access to the translator's account may be password protected such that the translator may sign in using the e-mail address and password selected for the translator's account. In some embodiments, a translator may access his/her account to view a list of all of the jobs (s)he has accepted and/or completed, along with how much money (s)he has accrued through each job since its completion date. In another example, a translator may access his account to view a royalty history, which may provide the translator with an overview of how much compensation (s)he has earned through the translation service and/or how much compensation (s)he is currently owed by the translation service (or a publisher). In another example, if the translator has set up a direct deposit to his/her bank account, (s)he can request to be paid whatever he is owed by at any point or during periodic intervals (or upon completion of a particular job), rather than waiting for the translation service to send him a check or otherwise pay him when a payment threshold is reached. In yet another example, a translator may edit the profile information associated with his/her account (e.g., personal information, payment information, and account information). In some embodiments, if a translator wishes to resign or remove himself from being a registered translator for the translation service, he can us the translation device 110 to close his account.

The admin device 112 may comprise, for example, a computing device operable to allow an Admin to perform one or more of the following functions: (i) add or remove documents (e.g., to/from a document database 102b); (ii) close or re-open jobs (e.g., from a job database 102c); (iii) issue payments (e.g., to Translators, Certifiers or Publishers); (iv) view documents available via the translation service; (v) close or suspend a user's account; (vi) view job summaries; and/or (vii) issue credentials for accessing accounts or aspects of the translation service system. An admin device 112 may comprise, for example, a desktop computer, a mobile or portable computing device such as a smartphone (e.g., the IPHONE manufactured by APPLE, the BLACKBERRY manufactured by RESEARCH IN MOTION, the PRE manufactured by PALM or the DROID manufactured by MOTOROLA), a tablet, a Personal Digital Assistant (PDA), cellular telephone or laptop or other computing device.

In accordance with some embodiments, the translation service may provide certain administrative functionality to authorized personnel. For example, admin software tools may allow an admin account to correct mistakes made by the system and users of the system and/or allow the admin to perform customer service functions as well. An admin may access such functionality in order to perform such tasks by use of the admin device 112.

In accordance with some embodiments, an admin may utilize an admin device 112 to perform one or more of the following functions: (i) access and view the full text of any document that has been posted to the system (e.g., both translated versions uploaded by translators and originals uploaded by publishers); (ii) access and view all job and document summaries stored in the system (e.g., a job summaries posted on the job board, document summaries and/or document listings available in a consumer catalog); (iii) remove and/or replace any documents stored in the system (whether original or translated); and (iv) remove any jobs posted on the job board (including the job summaries thereof). In some embodiments, permissions for an admin may be limited such that the admin may only perform the above-described functionalities to a limited extent. For example, an admin may only be allowed to delete or replace a document, for example, if a publisher has accidentally uploaded the wrong article and requests the admin's assistance. In some embodiments, removal of a document from the system may further prompt the admin to remove any corresponding jobs, job summaries, document summaries, translations and listings to be removed from the system as well. For example, if an original document had an egregious error that may lead doctors to prescribe fatal doses of a medication, all aspects of the document and related jobs may be removed from the system.

Other functionalities that an admin may perform by use of the admin device 112 include: (i) closing or re-opening jobs (e.g., removing a job from the job board or re-posting a job to the job board); (ii) modifying an account balance (e.g., in case the automated system incorrectly increments or decrements an account because of an accounting error, the admin can add or detract money from an account balance); (iii) view account histories (e.g., to settle any issues or disputes that may arise, which may also involve the admin reviewing any associated financial and job histories to investigate the issue or dispute); (iv) close an account and thus make it inactive for a user (e.g., the information from that account may be preserved, but the login credentials will not work when a user tries to access the account); (v) view activity related to testing (e.g., identify of a test taker, test date, test type (language or specialty), proctor associated with a test, test results, etc.); (vi) create or open a new account for a user (e.g., in some embodiments an admin may have authorization to bypass testing or other credentialing process, such as registering a user as a translator or proctor without requiring the user to take any associated tests beforehand); and (vii) associate and store credentials with an account, such as a specialty or a language level certification.

A proctor device 114 may comprise a computing device used by a Proctor to carry out certain methods of a Proctor as described herein. For example, a proctor device 114 may be operable to allow a Proctor to perform one or more of the following functions: (i) register with the translation service; (ii) review and/or grade tests; (iii) view royalty payments; and (iv) view an account history of a user. A proctor device 114 may comprise, for example, a desktop computer, a mobile or portable computing device such as a smartphone (e.g., the IPHONE manufactured by APPLE, the BLACKBERRY manufactured by RESEARCH IN MOTION, the PRE manufactured by PALM or the DROID manufactured by MOTOROLA), a tablet, a Personal Digital Assistant (PDA), cellular telephone or laptop or other computing device. In accordance with some embodiments, proctors are entities who are responsible for certifying the translators in the system. For example, proctors may be unique users in the system whose accounts are activated for them by an admin. In some embodiments, proctoring rights may be attributed to a translator account, similar to certifier status. In accordance with some embodiments, proctors may be provided with access to one or more functionalities or tools, via a proctor device 114. For example, a proctor may use a proctor device 114 to perform one or more of the following functions: (i) register or open an account (which may involve working with an admin or other operator of the translation service and involve providing information such as name, contact information (e.g., e-mail) and a password); (ii) log in and log out of his/her account using the email and password provided at registration; (iii) provide payment information usable for providing payment to the proctor; (iv) grade, score or review a test taken by a translator (e.g., once logged into the system a proctor may be able to access tests available for grading, select a particular test and select a “Start Grading” option (in some embodiments the system displays to the proctor the next available test in the proctor's language once a proctor logs in and indicates a readiness to grade, score or review a test); (v) view a history of the payments made to the proctor, plus current balance; and (vi) view a history of test graded or reviewed by the proctor.

In some embodiments, when a proctor begins to grade a test, the proctor may be provided the original text and the translator's translation, side by side. In some embodiments, the proctor may view the test remotely using the proctor device 114 (such that the test is stored on a remote device, such as the translation service server 102) while in other embodiments the proctor may download the test locally to his device. In accordance with some embodiments, proctors review the test and then provide a “grade”. In some embodiments, such a grade may comprise a Fail (not good enough), Level 1 (Good), Level 2 (Better), or Level 3 (Best). For example, the levels may correspond to the 3 passages translated, which will increase in complexity. After each reviewing (or while reviewing) a test, the proctor may be presented (e.g., via a display device of proctor device 114), with the options such as “Pause Grading”, “Finished Grading”, “Continue Grading” or “Stop Grading”. In some embodiments, if the Proctor finishes grading a test, the next available test may be served up to the proctor. In some embodiments, the proctor may select the “Stop Grading” option if the proctor has to discontinue grading for some reason (e.g., needs to pause and return later or determines that he can't grade the test due to a technical barrier (e.g., the test is in the wrong language).

The consumer catalog device 116 may comprise a computing device operable to output to consumers original and/or translated documents available for viewing, sale, lease or other access and use via the translation service. For example, the consumer catalog device 116 may comprise one or more server computers operable to maintain a website-based catalog (or maintain content for a website-based catalog hosted by another entity or server) and may provide one or more interfaces for allowing a consumer to (i) search the document catalog; (ii) view a summary of one or more documents; and/or (iii) contact or link to a document distributor. In accordance with some embodiments, a consumer catalog device 116 and a document distributor device 106 may be operated by or on behalf of the same entity. In some embodiments, readers or consumers interested in purchasing or otherwise accessing translated documents can visit a customer focused website of the translation service or otherwise communicate with the translation service to obtain access to such translated documents. Accessing the translation service via a website will not be described herein for purposes of brevity but it should be understood that offline access may also be provided in a similar manner. In accordance with some embodiments, such a website may host a catalog where consumers can browse available documents, view document summaries and/or link to a distributor that sells the content. The consumer catalog device 116 may comprise a server device on which such translated documents available to consumers are stored and/or which hosts a website via which the translated documents (or summary information about available translated documents) may be viewed.

In some embodiments, visitors or consumers can view a translation “Catalog” which provides a listing of the content (published translated documents) available in the visitor's preferred language. In some embodiments, only translations may be made available via the website, not original documents corresponding thereto. In one embodiment, the list may be shown up to X listings at a time, with breadcrumb pagination. The listings may include one or more of the following example information: (i) title of the document; (ii) publication in which the original document appeared; (iii) name of the author and/or translator of the document; (iv) a publication date (of the original and/or the translated version of the document), (v) a translation date; (vi) a portion of the translated document or a summary of the translated document (e.g., first x words for document w/out a summary); and/or (vii) a price for accessing the translated document (or whether it is part of a particular subscription plan).

In some embodiments, consumers may be provided with search tools for searching translated documents available in a consumer catalog and a consumer catalog device 116 may be operable to facilitate such searches. Searching criteria may include one or more of the following example criteria: (i) title of the original and/or translated document; (ii) publication in which the original document appeared; (iii) an author of the original document; (iv) a translator of the translated document; and/or (v) text of the translated document. In some embodiments, a consumer may be provided with tools to filter the catalog of translated documents to narrow the list of translated documents shown, using the one or more of the following example criteria: (i) a category, topic or subject matter of the translated document; (ii) a language of the translated document; (iii) an age of the document (original or translated); and/or (iv) a publication in which the original document appeared.

In accordance with some embodiments, a consumer catalog may include links or other access to additional details about the available translated documents, such as one or more of the following: (i) title of the document; (ii) an abstract of the document (or first X words if abstract is not available); (iii) languages in which the document is available; (iv) an original version of the document; (v) an author of the original document; (vi) a translator of the translated document; (vii) a date on which either the original or translated document was published; (viii) a link to a distributor of the translated document; (ix) a rating of the translated document; and/or (x) a price of the translated document.

With respect to the rating, it should be noted that in some embodiments, consumers who have accessed, purchased or otherwise reviewed a translated document may be provided with an opportunity to rate the document or translation of the document (e.g., 1-5). This rating may be presented as an average and may appear on the document summary. The rating may also be associated with the translator who translated the article. In some embodiments, in order to rate a translated document, a consumer may first need to set up an account and log in to the account (e.g., to hold people accountable for ratings). In some embodiments, a consumer may be allowed to leave a review about a translated document. This may provide more detailed feedback about bad translations and provide pertinent information to another potential consumer.

It should be noted that in one or more embodiments any or all of the devices 104 through 116 may store thereon a respective program or software application for enabling it to perform one or more of the aforementioned functions. In other embodiments, such programs or software may be stored on another device of system 100 (e.g., translation service server 102) and the device 104 through 116 may be operable to access such other device in order to perform the functions described herein as being performed by such device. It should further be noted that the functions described with respect to FIG. 1 as attributable to a particular device are exemplary only and other functions, uses and capabilities for each device are contemplated and described herein. Finally, it should be noted that communications among any of the devices of system 200 may occur over wires or cables, RF, cable TV, satellite links and the like.

In some embodiments, any of the devices of system 100 may include a program, a processor and a memory. The program stored in a memory of a given device may include instructions for directing a processor of the device to carry out one or more functions described herein as attributable to that device. The memory of a given device may comprise an appropriate combination of magnetic, optical and/or semiconductor memory, and may include, for example, Random Access Memory (RAM), Read-Only Memory (ROM), a compact disc and/or a hard disk. The processor and the memory of a given device may each be, for example: (i) located entirely within a single computer or other device; or (ii) connected to each other by a remote communication medium, such as a serial port cable, telephone line or radio frequency transceiver. In one embodiment, a device of system 100 may comprise one or more devices that are connected to a remote server computer for maintaining databases.

As would be understood by one of ordinary skill in the art, in accordance with some embodiments, the instructions of a program stored in a given device may be read into a main memory from another computer-readable medium, such from a ROM to RAM. Execution of sequences of the instructions in such a program may cause the associated processor to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

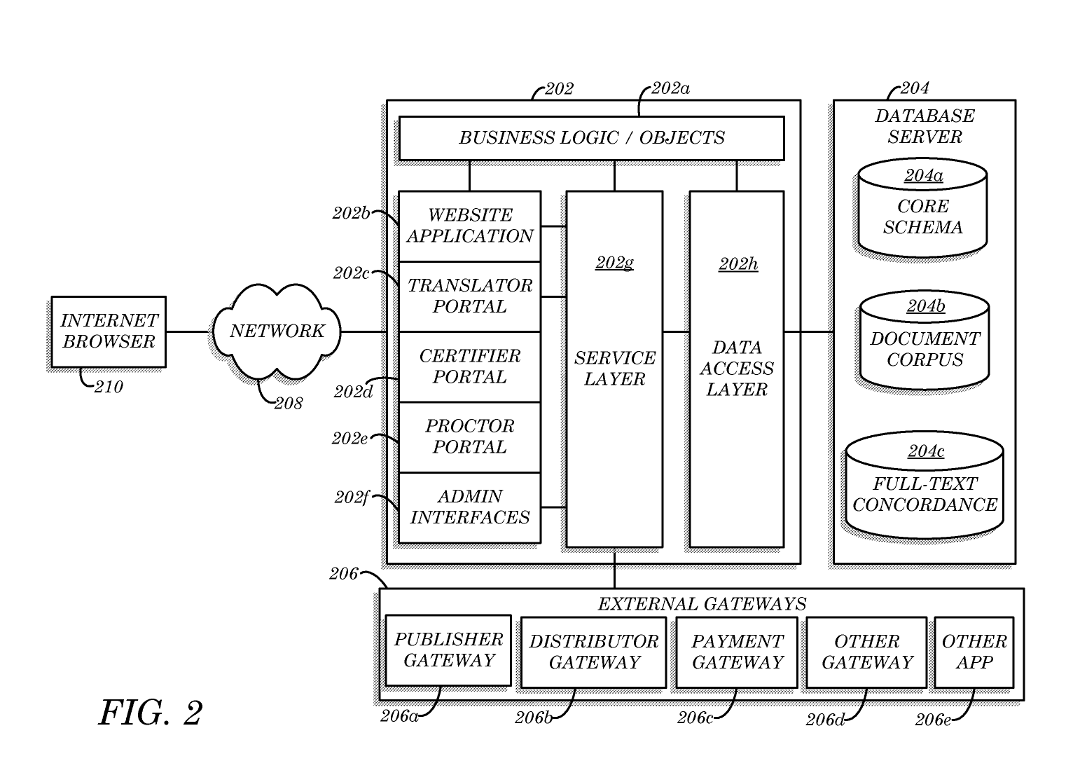

Turning now to FIG. 2, illustrated therein is a system 200 consistent with one or more embodiments described herein. The system 200 comprises one or more instances of a web server or web server container 202 (which may be comprised of software and/or hardware), such as Apache Tomcat™ developed by the Apache Software Foundation™. The web server 202 may, in some embodiments, comprise the translation service server 102 of FIG. 1. The web server 202 may be operable to help deliver content accessible through the Internet, such as information regarding translation jobs and translated documents. For example, the web server 202 may be operable to host a website of a translation service as described herein, as well as to store content such as documents, jobs and user accounts. The web server 202 includes a business logic or objects 202, which is operable to communicate with (i) a website application 202b; (ii) a translator portal 202c; (iii) a certifier portal 202d; (iv) a proctor portal 202e; (v) an admin interface 202f; (vi) a service layer 202g (e.g., operable to manage job queuing, a testing engine, etc.); and (vii) a data access layer 202h. The content available via the web server 202 may be accessible (directly or indirectly, via a wired or wireless medium) to users using an internet browser 210 via a network 208, which may comprise the Internet, an intranet, a LAN, a WAN or Ethernet, Token Ring, or via any appropriate communications means or combination of communications means. As with system 100, it should be noted that communications among any of the devices of system 200 may occur over wires or cables, RF, cable TV, satellite links and the like.

As described, the business layer 202g may be operable to manage job queuing and/or a testing engine. A testing engine may consist of software operable to serve up instructions to a test taker when a test is taken (e.g., in a small pop-up, if the test is being taken online) and/or the content of the test. For example, in accordance with some embodiments, each test may require a unique set of passages selected from a larger document to be translated. For example, 6 passages may need to be selected: level 1, 2, 3 in a first language and level 1, 2, 3 in a second language. In such embodiments, a testing database may be stored and accessed to store and access passages in all supported languages and in 3 different levels of complexity. It should be understood that the numbers used herein are for illustrative purposes only and that any other number may be used. In accordance with some embodiments, when a translator finishes a test, (s)he submits the test and the originals+translations are stored (e.g., also in a test database).

In accordance with some embodiments, a grading queue is built (e.g., by a testing engine supported by the business layer 202g) as tests are submitted, with the most recent tests being slotted at the bottom of the queue and the oldest tests slotted at the top. As described with respect to a job board herein, there may be queues for each language or one main queue.

In accordance with some embodiments, a testing engine may be operable to serve completed test requiring grading to available proctors. For example, when a Proctor selects a “Start Grading” option on an interface, the system may provide him with the next test in the grading queue. In some embodiments, the testing engine may further be operable to store a proctor's grade or score for a given test (e.g., in addition to or in lieu of such a grade or score being stored in a user account in association with the user who took the test). In some embodiments, the testing engine may be operable to transmit the results of a test to the user who took the test (e.g., via an e-mail notification).

In accordance with some embodiments, the account of the translator or applicant who took a given test may be automatically affected by the results of the test. For example, once the test grade is inputted into the system, the translator may be able to perform jobs corresponding to the qualifications provided by the proctor. The translator may receive a translation level qualification or a specialty qualification by virtue of the test grade or score, each allowing the translator to perform work

The system 200 may further comprise a database server 204, which may store data or content for facilitating the methods and functionalities described herein. The database server 204 may comprise, for example, a MySQL™ Database Server and/or Lucene full-text indexes. The web server 202 may be operable to communicate with the database server 204, directly or indirectly, to access data, content and/or one or more programs. For example, the database server 204 may store one or more of a core schema 204a, a document corpus 204b and a full-text concordance 204c.

In accordance with some embodiments, the web server 202 may be operable to interface with (e.g., via a service layer 202g) with one or more external gateways or applications 206 in order to allow communication and/or data exchange with one or more of other devices (e.g., one or more of the devices illustrated in FIG. 1). As a non-limiting example, the external gateways illustrated in FIG. 2 consist of a publisher gateway 206a, a distributor gateway 206b, a payment gateway 206c, another gateway 206d (e.g., to an EPUB Processor) and another external application 206e (e.g., a translation engine).

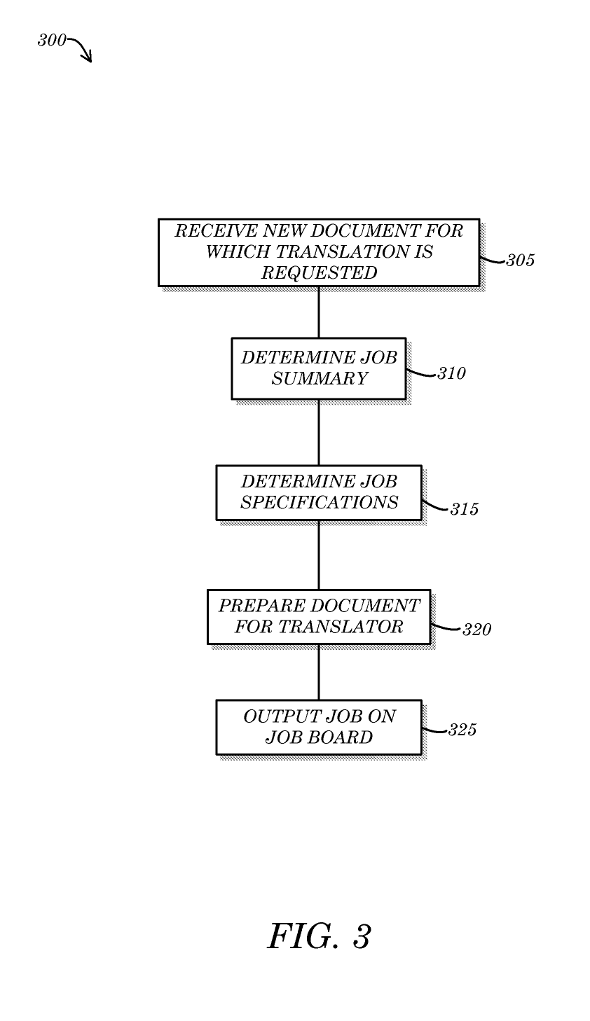

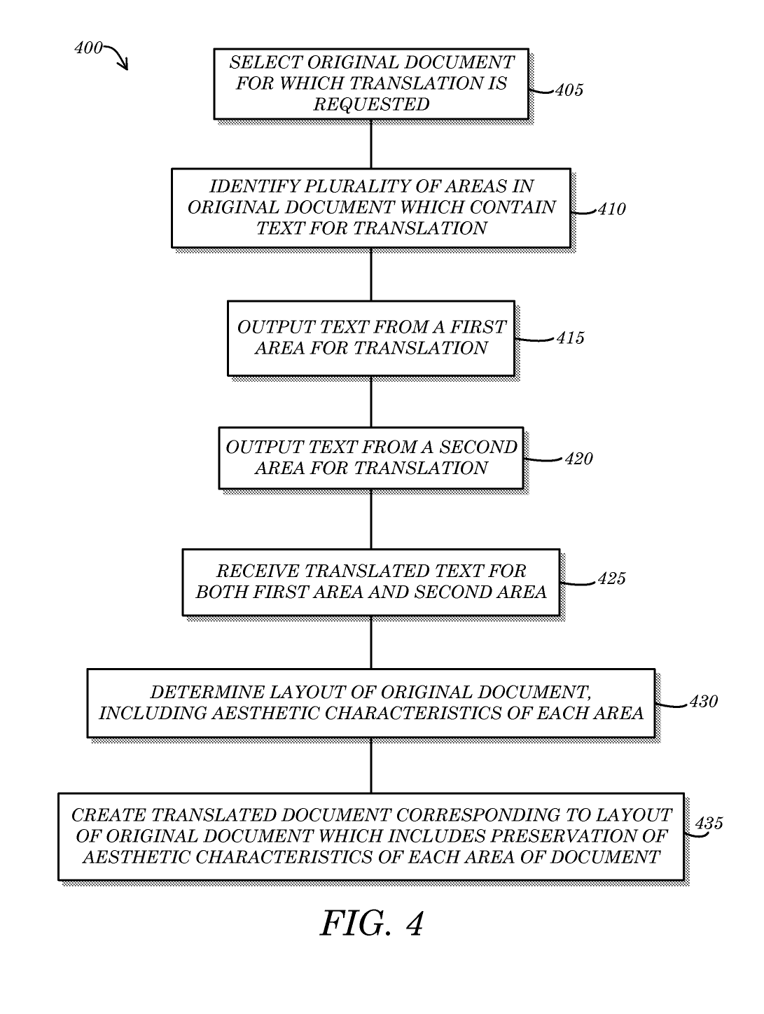

Turning now to FIG. 3, illustrated therein is an example process 300 which is consistent with some embodiments described herein. It should be noted that process 300 (as well as processes 400, 500 and 600, described in FIGS. 4, 5 and 6, respectively) is exemplary only and should not be construed in a limiting fashion. For example, additional and/or substitute steps to those illustrated may be practiced within the scope of the presently described embodiments and in one or more embodiments one or more steps may be omitted or modified. In one embodiment, the process 300 is performed by translation service server 102 and/or a web server 202 and comprises a process for creating and posting a new translation job on a job board. For example, a publisher may request that a new “job” be opened in the system, for translating a document from its original language, which may require a job summary to be received or created. In one embodiment, a publisher requesting translation of a document may be prompted to provide the following information in order for a new job to be opened in the system: (i) document specifications (e.g., general information about the document); (ii) payment specifications (e.g., settings and/or selections which define the financials of the translation job); and (iii) job specifications (e.g., settings and/or selections that define who and how the job gets done and other requirements for a successfully completed job). Example steps of creating a new job in the system may comprise (i) uploading the document; (ii) uploading a document abstract; (iii) filling out job specifications; (iv) choosing payment options; and (v) choosing job specifications.

A new document for which translation is requested is received in 305. A document may be received for translation from a publisher when, for example, it is received or uploaded from a publisher device. In accordance with one or more embodiments, publishers upload their works for translation, give directions on the translation process, and exercise various control over their translated documents. In one embodiment, the translation service may only accept certain document types such that there may be restrictions on the characteristics of a document (e.g., document may only be in certain formats, having to do with certain topics, be ones that have been peer reviewed, or up to a maximum upload size). In some embodiments, step 305 may also comprise receiving a document abstract. For example, a publisher may be prompted to upload a document abstract upon uploading a document. In some embodiments, there may also be limits which apply to the uploads of abstracts (e.g., maximum word count, format). In some embodiments, if an abstract is not provided, the translation service may create one (e.g., by lifting the first predetermined number of words of the document). In accordance with some embodiments, documents uploaded to the system may be required to be uploaded or otherwise provided in a particular format (e.g., as a .doc file). In some embodiments, if a distributor requires that a document be converted to a different file type, then the system may be operable to convert the document to the required format or request the document in the required format from the publisher; in either embodiment, the system may then save that document in association with the prior version+original. In addition, in some embodiments the system may add components to the document (e.g., publisher tracking elements such as watermarks, embedded tracking codes, publisher branding, translation service branding, etc.). Thus, in some embodiments, receiving the document for translation may comprise (i) determining whether the document is in a required or preferred format and, if it is not, (ii) rejecting the document and/or outputting a message to the publisher to resubmit the document in the required or preferred format. In some embodiments receiving the document for translation may comprise editing, modifying, reformatting and/or storing the document.

Once a document is received, a job summary is determined in 310. For example, a job summary may be created or provided by a publisher or may be created by the translation service based on information provided by a publisher. Creating or determining a job summary may comprise, for example, prompting the publisher to provide certain document specifications (or determining the document specifications from the received document). Such document specifications may consist of, for example and without limitation, (i) title of document; (ii) an indication of publication; (iii) a publication date; (iv) a volume/issue of the publication; (v) a language of the uploaded document text; (vi) an ISBN of the document; (vii) an author(s) of the document; and/or (viii) a subject or topic of the document (e.g., may select from a list of acceptable topics and may help translators quickly understand the topic).

Creating or determining a job summary may, in some embodiments, further include determining one or more payment options for the job. In accordance with some embodiments, a publisher may choose from one or more payment options to customize how the publisher would like to be compensated (in other embodiments, the translation service may provide a default compensation scheme to Publishers) and/or how the publisher would like to pay the translation service for its services. For example, in some embodiments the publisher may be allowed to indicate whether he wants to pay a translator of the document upfront and collect a large majority of the translated document's sales revenue, or if he wants to pay no upfront cost for translation, and instead split the revenue with the translator. In other words, the publisher may be provided an opportunity to decide whether to take some risk up front by paying for the document's translation but collecting most of the revenue if the document sells, or taking little or no risk by allowing the translator(s) to share in the revenue stream with him. One example payment option comprises indication of an upfront payment in which a publisher pays a predetermined amount of money each time his document is translated into a new language. In some embodiments, a publisher may be involved in determining the payment amount to be provided to a translator of the document. In some embodiments, the translation service may recommend an amount based on the document's word count or other characteristics. In some embodiments the payment to a translator may be based on the particular language into which the document is translated. In other embodiments, a publisher does not pay for his document to be translated into a new language but rather chooses to share in the revenue stream from sales of the translated document. In such embodiments, the publisher may indicate a royalty rate or split to be shared with a translator(s) of the document. In some embodiments, a royalty scheme specified by a publisher may specify different royalty rates which vary based on the sale price (or total revenue stream) of the translated document.

Once a job summary is determined or created, job specifications are determined in 315. The job specifications may be determined by the translation service by, for example, prompting the publisher to provide certain additional information which will aid the translation service in identifying the appropriate translator for the translation job.

In some embodiments, determining the job specifications may include determining which one or more languages the publisher desires the document to be translated into. In some circumstances, a publisher may request that the document be translated into any language for which a translator is identified. In some embodiments, language translation may be driven by demand (e.g., if enough users indicate they want to purchase or access the document in a certain language X, the publisher may allow (e.g., by setting certain rules for the translation service to use in making such a determination or in response to a query from the translation service) the document to be published in that language X. In some embodiments, in accordance with some embodiments, a publisher can choose to prevent the document from being translated into certain languages (e.g., language exclusion).

In some embodiments, determining the job specifications may include determining a date by which the translation job is to be completed and/or a date by which the document or job will be removed from the translation service. For example, a publisher can choose a date that the document will be pulled from the translation service. In some embodiments, the translation service may have rules on minimum deadline length.

In some embodiments, determining job specifications may comprise determining some labor-related specifications regarding the document for which translation is requested. These specifications may include specifying, for example, the level of proficiency of a translator who can work on his document. For example, a publisher may be prompted to indicate the minimum proficiency level of a translator who can work on the document (i.e., the job may only be offered to translators who meet a minimum level of ability in regards to translation; this level of proficiency for a translator may be determined based on translation tests given to translators who register with the translation service). In another embodiment, a job specification may comprise an indication of whether another translator (or certifier) should review the translation. For example, if a publisher indicates that another translator or certifier review the translated document before the translated document is published or made available to consumers, the pricing structure may reflect this choice. For example, an additional upfront payment may be added on to the payment due to the translator or a smaller portion of the downstream revenue may be attributable to the translator such that some of the downstream revenue stream is attributable to the certifier or additional translator. In one embodiment, a job specification may include an indication of whether a special knowledge set is needed to accurately translate the document (a specialty of a translator). For example, a publisher may be allowed to specify that only translators who have passed a test indicating they are qualified or skilled in a “specialty” (e.g., genetics, bioengineering, periodontology, etc.) be allowed to work on translating the document if the publisher determines that the mastery of a certain knowledge set is needed to accurately translate the document. In such a circumstance, the job may only be made available to translators who meet a minimum level of ability in regards to specialized knowledge. This ability may be tested and assessed by the translation service.

In some embodiments, a job specification may comprise a price for which the translated document is to be sold or otherwise made available to consumers. In accordance with some embodiments, a publisher of a document will choose the retail price of the translated document. In some embodiments, the translation service may help guide the publisher on the retail price but the publisher may have final say. In other embodiments, the translation service may set the retail price (e.g., in some embodiments, publisher may have approval or veto power over this). In still other embodiments, the retail price may be demand based, fluctuate on various considerations and/or may be included as part of a subscription fee paid by users of the translation service (i.e., users who access or purchase access to translated documents offered by the translation service). In some embodiments, a price may vary by translation and/or by a customer's country of residence. In some embodiments, the translation service may set a price floor and/or ceiling for all translated documents or based on category or other characteristic of a translated document. In some embodiments, the translation service may provide automated price suggestions based on characteristics of a translated or original document, such as the length, language (language being translated from and/or language being translated into), complexity, economic status of targeted buyers, original language price or other characteristics of the document or publisher.

In step 320 the document received in 305 is prepared for translation. Preparing a document for translation may comprise, for example, saving the document in a particular file format or layout, parsing or segmenting the document into portions to be translated, spellchecking the document, and/or uploading or transmitting the document to a particular device or storage location accessible to translators. FIG. 4, described below, illustrates an example detailed process for how a document may be prepared for translation.

In step 325, the job is output on the job board. A job board may comprise a website (or particular page thereof) on which there are posted translation jobs consisting of documents for which translation has been requested. As described herein, translators who have been accepted into the translation service (either as freelancers, consultants, employees or otherwise) may take jobs posted on the job board, translate the document into another language, and submit the translated document to the translation service for publishing. Thus registered translators may be able to select jobs from the job board, read the requirements of that job (e.g., job summary and/or job specifications), and fulfill that job by submitting the translated document to the translation system. In other embodiments, the translation service may contact qualified translators directly, with offers for available jobs, in lieu of (or in addition to) passively posting the available jobs on a job board.

In some embodiments, outputting a job to the job board may comprise posting a job summary, which includes the language of the original document, the language(s) into which translation is requested and/or any specialties in which a qualified translator must be certified in order to perform the job. Other examples of information which may be included when outputting a job on a job board include, without limitation, (i) the title of the original document, (i) a publication in which the original document appeared, (iii) a word count of the text to be translated (which may be calculated by the system), (iv) payment details for the payment scheme according to which the translator is to be paid, (v) languages into which the original document has already been translated, (vi) a deadline by which the translation is to be completed (if any), and (vii) a subject or topic of the document. Thus, in some embodiments, a translator viewing a job board may be presented with some or all of this information about available jobs.

In some embodiments, a job board may include one or more of the following functionalities: (i) an automatic filter or sorter which enables the translation service to automatically filter or sort the job board to only show those jobs that a given translator who is viewing the job board is certified to do; and (ii) a manual filter or sorter which allows the translator to filter or sort the job board by various criteria, including date posted, certified language, certified specialty, subject, and price. Similar to filtering, in some embodiments a translator may be provided with an interface on the job board which allows a manual and more detailed search of the available jobs in order to search for a job corresponding to specific criteria (e.g., a specific document, title, publication in which the original document appeared, an author of the original document, a translator of a document already translated into a language, test in the document to be translated).

In accordance with some embodiments, when a translator decides that he wants to translate a given document, he may claim that job from the job board. Claiming a job from the job board may comprise the translator indicating to the translation system which of his certified languages he is going to translate that document into. Thus, other translators can still claim that job in a different language. In other embodiments, each language into which a particular document is to be translated may be posted as a separate and distinct job and thus there would be no need for the translator to indicate this information; the translator would simply claim the job corresponding to the particular language (s)he is interested in translating the document into. In some embodiments, once a job is claimed, it may be taken off of the job board for that particular language or otherwise made unavailable (e.g., grayed out, a link to the job details disabled, a field for indicating claiming of the job filled in, removed or disabled, etc.). This ensures that two people cannot work simultaneously translating the same document into the same language.

In some embodiments, a job may be abandoned by a translator before it is completed. If a job is “abandoned” it may be made available again on the job board in that language. The following are some example ways in which a job can be abandoned: (i) after claiming a job, if translator decides that he does not want to work on the job anymore, the translator indicates to the system that he is abandoning the job; (ii) if a job is claimed but its deadline passes, it is automatically considered abandoned and the system notifies the translator; and (iii) if a job is claimed and the translated document is not posted back to the system within a certain period of time, the job is automatically considered abandoned and the system notifies the translator.

It should be noted that additional and alternative steps may in some embodiments be included in process 300 or a related process. For example, in some embodiments a publisher may be provided with an opportunity to edit job information such as a job summary and/or job specifications (e.g., such opportunities may vary based on phase in the translation process). In another example, a publisher may be allowed to remove one of his jobs at any time if it is not in the process of being translated or request that the translation service remove the job from the job board and/or the system. For example, a publisher may request that the translation service remove a document that has been published or is in the process of being published from the translation service. It should be noted that a document being published from the translation service may comprise the document being made available for viewing, purchase, access or distribution. In some embodiments, if the document is being translated at the time of such a request, the translator may be notified to stop the translation. In one or more embodiments, a publisher may have to pay the parties associated with the translated document for the deprival of further revenue (amount may vary).

In one or more embodiments, a publisher may be provided with an opportunity to review one of his published translated documents (or documents in the process of being translated) at any time.

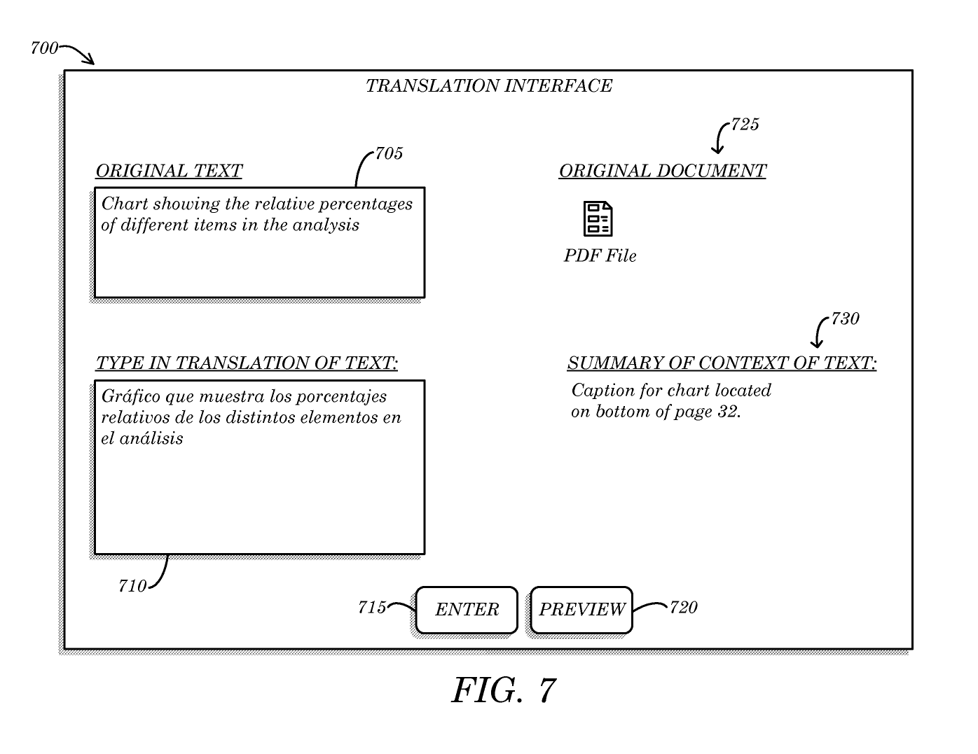

Turning now to FIG. 4, illustrated therein is an example process 400 for handling a document received for translation and preparing them for output to a translator who claims a job corresponding to the document. The process 400 may be performed by, for example, the translation service server 102. It should be noted that the description of FIG. 4 includes reference to FIG. 7, which comprises an example illustration of an interface via which a translator may be presented with text for translation and input translated text.

In accordance with some embodiments, a translator may not download the original document for translation and then upload a translated version of the document because (i) the original document may be in a format that cannot be opened or manipulated by the translator; and/or (ii) the original document may have layout, aesthetic and formatting characteristics which would merely be a distraction to the translator (e.g., a translator who is provided with the entire document and asked to translated it may be slowed down, frustrated or distracted with non-translation issues related to preserving the layout and aesthetic characteristics of the document). In other words, in some embodiments the system may manage translation of documents by providing to the translator an interface for viewing and translating only the text of an original document, in order to minimize any investment of time and resources by the translator into having the appropriate software for viewing any non-text objects or images in the document, having the appropriate software for reading the file format of the document, formatting the document, etc.

Accordingly, a translator may be provided with an interface that facilitates translation by focusing the translator's efforts only on providing a translation of the text of the document, such as the example interface illustrated in FIG. 7. The main functions of the translation interface may be to provide the original text or other content for which translation is requested to the translator for translation and to provide an input interface for allowing the translator to input the translated version of the content (e.g., the translated text).

The original document for which translation is requested is selected (405). For example, the document may be retrieved from a document database (e.g., document database 102b of FIG. 1). In another example, step 405 may comprise receiving the document from the translator (e.g., step 405 may be triggered, and the process 400 initiated, upon receiving a new document for translation in step 305 of process 300).

A plurality of areas in the original document which contain text for translation are identified (410). For example, human employees, OCR or a specialized program may be utilized to segment the document into areas which include text for translation. Such areas may include, for example, paragraphs of words, photo or image captions, headers, headlines and title, tags or identifiers in charts or graphs, etc. Thus, in some embodiments any text from the document may be extracted from the document for purposes of translation. Step 410 may further include determining a layout of the original document (e.g., a positioning of each of the areas relative to one another and relative to any areas which do not include text, such as images, graphs, charts, etc.) and/or any aesthetic or layout characteristics of each area (e.g., font size, font style, font color, line numbering, line spacing, etc.). As described above, a document may correspond to certain particular layout that comprises a set of characteristics and choices which together provide a specific aesthetic appearance to the content of the document. Examples of characteristics which may contribute to a particular layout include, without limitation, a page layout (e.g., 2 column layout, horizontal vs. vertical page orientation), font size, font style, font color, line spacing and background fill. In some embodiments, each area of a document may be associated with a particular set of characteristics and a particular layout of the document may consist of the totality of the areas as they are positioned relative to one another and the respective set of characteristics of each area. Step 410 (or another step of process 400 or another process) may thus include storing (e.g., in a document database 102b) an indication of the layout of the document and/or one or more characteristics of the document and/or particular areas of the document.

Continuing with FIG. 4, the text from a first area of a document is output to a translator for translation (415) and the text from a second area of a document is output to a translator for translation (420). Thus, the original document is segmented into portions for which translation is requested separately. It should be noted that the translator translating the text from the first area may be the same person/translator who is translating text from the second area (alternatively, the text from each area may be output to a different translator). It should further be noted that the text from the first area and the text from the second area, if being output to the same translator, may be combined and output simultaneously or in parallel (e.g., via the same communication or interface).

The translated text for each area of the document is received (425). For example, the text could be e-mailed by the translator or received via an interface of a website operated by or on behalf of the translation system 100. In embodiments in which the text from both areas was output to the same translator, the translated text from both areas may be received simultaneously (e.g., if the text from both areas was output simultaneously or in parallel) or at different times (e.g., if the text from the two areas was output in series or via different communications or interfaces).

In FIG. 7, element 705 comprises an interface via which text from an original document is presented to a translator and element 710 comprises an interface via which a translator would enter the translated text corresponding to the original text output in element 705. It should be noted that, for purposes of simplicity, FIG. 7 illustrates only a single element 705 for outputting text. The text in the element 705 may, in some embodiments, be text only from a single area of an original document. In other embodiments, text from two or more areas may be combined and output simultaneously to a translator (e.g., in the element 705).

It should further be noted that the example interface 700, while outputting the text for translation via element 705, also includes additional information about the original document that may be helpful to the translator in order to put the text into context, which may aid in determining the appropriate translation in some circumstances. In particular, the interface 700 includes a PDF file of the original document (in element 725) and a summary of the context of the text for which translation is requested (in element 730). Of course, other types of information about the context of the text and/or the original document may be utilized (e.g., a link to a publication of the document, translations to other language of the text, etc.). The example interface 700 also includes a mechanism for the translator to enter or submit the translated text once it is input to the translator's satisfaction (715) and a mechanism for the translator to preview the translated text (e.g., in the context of the document, formatted as it will appear in the translated document, etc.).

Returning now to FIG. 4, the layout of the original document is determined, including the aesthetic characteristics of each area (430). This step may comprise, for example, retrieving such layout and/or characteristics from a database or other memory (e.g., document database 102b) as they were previously stored. The translated document is then created in step 435 based on the determined layout and aesthetic characteristics of the document and translated text from both areas (and the translated text from any other areas for which translation was requested and received), such that the aesthetic characteristics and appearance of the document is preserved as much as possible given the differences introduced by virtue of the translated text (e.g., different appearance of letters, different lengths of words and paragraphs, etc.). Step 435 may comprise, for example, inserting or applying, automatically, the visual or aesthetic components of the original document into the translated version of the document when the translated text is ready or replacing the original text with the translated text. In one embodiment, the system may perform automatic formatting or reformatting and thus create a translated version of the document by mapping the layout from the original document onto the submitted translation. In such a case, headers, titles, subheadings, image captions, and text in graphs figures and charts may be provided separately by the translator. This text may even be requested by the system, separately from the main document text.

It should be noted that in some embodiments step 430 and/or step 435 is not performed until a certifier has approved the accuracy and appropriateness of the translated text. For example, the system may not desire to expend resources on creating an entire translated document (including any automatic formatting or determination thereof, etc.) unless and until it is verified by a certifier that the translated text received in step 425 is approved.

A translation process such as process 400 may aid in preserving the visual or aesthetic components of the original document, such as formatting and images, with minimal investment of resources in preserving such components on the part of a translator. For instance, the system may intelligently segment the document, instruct the translator to translate specified blocks or segments of text, and then re-construct the original document using the translated text. In other words, in some embodiments the system may be operable to perform automated document formatting in order to create a translated document based on translated text provided by translators. For example, automated document formatting may occur when prepping a translation to be passed on to a distributor. Because the original document may be in a format that cannot be opened or manipulated by the translator, the translator might only be required to work with and translate the document's text. Thus, it is the translation service (or a third party service retained by the translation service for this purpose) rather than the translator who is responsible for preserving or formatting the visual or aesthetic components of a translated document, such as the layout style, font characteristics (e.g., font style, size and color), heading placement, subheading placement, placement of graphs, figures, charts, images and other non-text components of the document.

As described, a benefit of a process which may automatically identify and extract the visual or aesthetic components of an original document and recreate, preserve or mimic such components in a translated version of the document which would limit a translator's responsibilities and focus on the translation of the text in the document. It should be noted that the timing of automated document reformatting may depend on whether or not the system has a translation interface, or if it requires the Translator to upload and download documents.

Turning now to FIG. 5, illustrated therein is an example process 500 for handling of a translated document which has been received from a translator. The process 500 illustrates an embodiment in which a certifier is involved in approving at least some translated versions of document before they are published or provided to a document distributor or pubisher.

In step 502, the translated document is received. This may comprise, for example, receiving the entire translated document from a translator. In other embodiments (such as those described with respect to FIG. 4), step 502 may comprise receiving a translated document as it is created by the translation service based on translated text received from the translator (in such embodiments one aspect of the certifier's job may be to approve the layout and visual appearance of the document as well as the accuracy and appropriateness of the text translation, such that the certifier may serve as a “second pair of eyes” on the document, ensuring that any automated formatting and layout is appropriate). In still other embodiments, step 502 may comprise receiving merely the translated text of the document but not an entire translated document.

In accordance with some embodiments, once a translator has translated a document (or text thereof) into another language, he needs to upload the translated document (or text thereof) along with a translated job and/or document summary (e.g., for both the job board and for the document summary for when the document is published). Thus receiving the translated document may comprise receiving the translated document (or text thereof) once it is uploaded or otherwise entered into the system (e.g., e-mailed by the translator, entered via an interface such as the interface of FIG. 7, etc.). In some embodiments, receiving the translated document may also comprise receiving a job summary from the translator.

In step 504 it is determined whether a certification of the document is required. For example, a job specification of the job for which the translation is received may be accessed in order to determine whether the publisher who submitted the document for translation requested that the translated document be reviewed by a certifier. In accordance with some embodiments, if a publisher requests in the job posting, a certifier will review each translation of an original document each time it is translated before the translation is published. If not certification of the document is determined to be necessary, the process 500 continues to step 506, in which step the translated document is published (e.g., forwarded or queued for forwarding to a document distributor or posted to a catalog or site via which consumers may gain access to (e.g., purchase) the translated document).

If a certification is determined to be necessary, the process 500 continues to step 508 in which step the translated document is provided to a certifier. Providing the translated document to a certifier may comprise, for example, posting a job on a job board (e.g., a job board for certifiers, in a queue or other listing of jobs consisting of translated documents which require certification). In such embodiments, the certification or review of the document may not occur until a certifier claims the job. In other embodiments, step 506 may comprise transmitting (e.g., via an e-mail) the translated document (and, e.g., a copy of the original text and/or original document) to a certifier with a request that the translation be reviewed. In yet other embodiments, step 508 may comprise transmitting an offer (e.g., via an e-mail) to one or more certifiers to agree to review the translated document (or text thereof).

Once a certifier reviews the translated document (or text thereof), the certifier may approve the translation for publication. If this is the case, the process 500 continues to step 506 and the translated document is published. In embodiments in which the translated documents still needs to be created (e.g., only the translated text of the document was output to a certifier for approval but the automatic formatting, determination of layout, etc. was not yet performed to create an entire translated document), the process may first include creating the translated document (e.g., in a manner similar to that described with respect to step 435 if FIG. 4) based on the approved translated text.

If the certifier does not approve the translation, it is determined whether the certifier provided a modified version of the translation (e.g., the certifier may modify the translation (e.g., if only minor corrections are needed) and provide the modified/corrected version of the translation for publication). If the certifier provides a modified translation, the process 500 continues to step 514 in which the modified translated document (or modified translated text thereof) is published. In embodiments in which the translated documents still needs to be created (e.g., only the translated text of the document was output to a certifier for approval but the automatic formatting, determination of layout, etc. was not yet performed to create an entire translated document), the process may first include creating the translated document (e.g., in a manner similar to that described with respect to step 435 if FIG. 4) based on the modified translated text. If the certifier does not approve the translation nor provides a modified version of the translation, the translation is considered as rejected (step 516). In such an event, the certifier may also provide a rejection summary and/or details of why the translation was rejected.

If a certifier rejects the translated document (or text thereof), the translator may be notified and will be able to read the rejection summary. A rejection summary may, for example, be written in English (or another base language) explain why the certifier rejected this document, pointing out the various flaws and making a case for why this translation should not be published. The rejection summary may be attached to or submitted along with a decision as to the accuracy of the translation and may be stored by the system for a period of time.

In some embodiments, if a translator has his translation rejected by a certifier, he can appeal that rejection. If rejection is appealed, another certifier will review it. Upon second or other subsequent rejection, the translator may be unable to appeal the rejection of his translation again. In some embodiments, when a translation has been rejected, there may be a maximum amount of time (e.g., X hours from the time the rejection is received in the system) during which the translator has the opportunity to appeal, after which period of time the translator will not be able to appeal.

In some embodiments, process 400 (or another process initiated upon the completion of process 400) may comprise steps for determining the appropriate payment to provide to a certifier upon completion of a certifier's job. In accordance with some embodiments, certifiers may be paid in royalties when they approve a translated document. However, when a translation is rejected by a certifier, the certifier may nevertheless need to be paid for his effort. Therefore, in accordance with some embodiments, the system may be operable to pay a certifier a predetermined amount when a translation has been rejected (e.g., an amount is based on the word count of the translated document). In accordance with some embodiments, a certifier who rejects a translation may only be aid after an appeal has been finally decided, or after the expiration of the appeals period. In some embodiments, a certifier may be paid an hourly wage regardless of the outcome of a job.

In accordance with some embodiments in which the system is operable to receive an appeal from a translator who disagrees with a rejection, an interface may be provided on a website of the translation service for allowing a translator to submit an appeal. For example, a website may include an “appeal window” into which the translator may enter his appeal. When the translator notifies the system of an appeal, the system may, in some embodiments, not repost the job to a job board until after the appeal is resolved (if applicable). In some embodiments, a translator may be allowed to post a response to a rejection or Appeal.

In some embodiments, appeals may be assigned to an admin of the translation service. In some embodiments, such an assigned admin may contact a proctor or other appropriate party to discuss resolution of the appeal. In accordance with some embodiments, when an appeal is assigned to an admin, one or more of the following may be made available (potentially gathered by an admin and transferred to the proctor or other appropriate party) in order for a decision to be made: (i) the original document; (ii) the translated document (or translated text thereof); (iii) a rejection summary or detailed reasoning for the rejection; and (iv) a translator's response to the rejection, if any.

In accordance with some embodiments, once a document is submitted for publishing (e.g., in step 506 or step 514 of process 500), the translation service may save it as the final translated version of that document. For example, the approved translated document may be saved in the document database 102b in association with the original document.

In some embodiments, a certifier may be prompted to (or provided an opportunity to) provide feedback as to the quality of the translation, in lieu of or in addition to merely approving, disapproving or modifying it. For example, although a certifier may determine that the translation is sufficiently accurate for approval for publication, the quality of the translation may nevertheless be poor or merely mediocre and the system may find it beneficial to solicit and track such feedback (whether through a quantitative rating system or a free-form and qualitative feedback system) from certifiers.

In accordance with some embodiments, as a translator who works for the translation service may earn or accumulate a rating. In some embodiments, this rating may be a composite score of the work (s)he has completed weighed against any rejected or abandoned work (s)he participated in. In some embodiments, purchasers of the translated work may also provide input that is taken into account in determining such a rating. In some embodiments, the rating may not be outward facing (i.e., available to publishers or consumers of the service). Instead, it may serve as an internal number that allows the translator to see if he is in good standing with the translation service. For example, in some embodiments if the translator's rating falls below a predetermined minimum, he may be suspended or fired from working for the translation service or may have his proficiency level reduced (thus no longer qualifying for certain jobs).

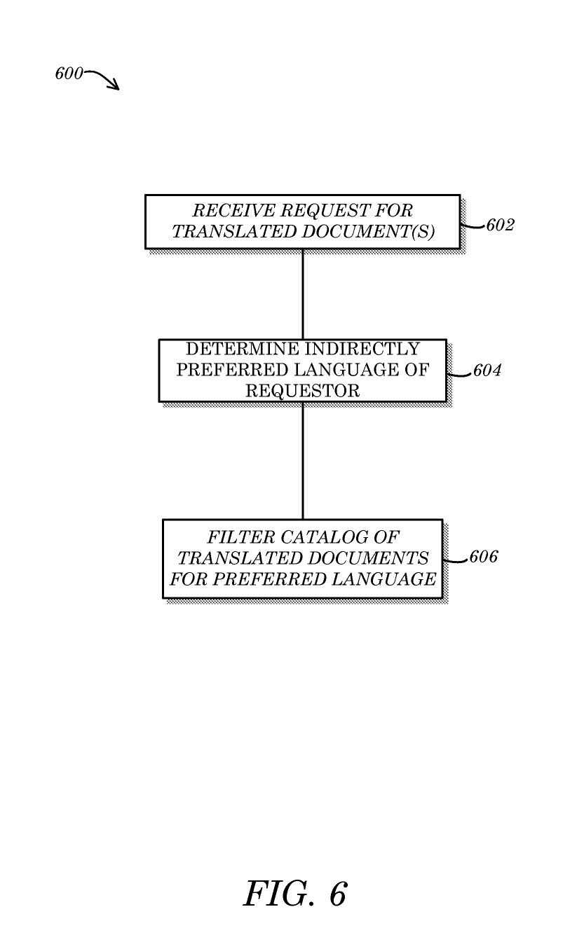

Referring now to FIG. 6, illustrated therein is an example process 600 for determining a preferred language of a consumer who desired to access translated documents. The process 600 may be performed by, for example, the translation service server 102.

In accordance with some embodiments, the website for presenting translated documents may be available in multiple languages, and the language that is shown to a visitor or consumer may be selected based on an IP sniff, to determine information associated with the consumer's device (e.g., the IP address of the device). For example, the language of the consumer requesting to view translated documents may be important in some embodiments in which the available translated content is filtered based on which content or documents are available in the selected language. For instance, French language content may not be shown on the Arabic version of the site. In some embodiments, all “versions” of the website may be available to any visitor. In some embodiments, the website is exactly the same in all languages, aside from the fact that the content featured or in the appearing catalog may differ based on which are available in the displayed language. In other embodiments, there may be other differences in the different versions of the website.

Process 600 is one example process in which content of a preferred language may be automatically presented to a user based on an automatic determination of the preferred language. It should be noted that process 600 may be applied to any website on which content is available in multiple language or which is available in multiple language versions.

A request to view translated documents is received in step 602. Such a request may comprise, for example, a request from a computing device to view content of the consumer catalog or other website or to view the website.

In step 604, the preferred language of a user of the computing device from which the request is received is determined, the preferred language being determined indirectly. In other words, the preferred language is determined on behalf of the user and comprises a determination other than from a direct or express indication of a preferred language being input by a user for purposes of determining the appropriate content to present to a user via a website. For example, the IP address of the computing device may be determined. In another example, cookies stored on the computing device may be accessed, to determine other websites recently visited by the computing device. Thus, the preferred language of the user of the computing device is inferred.

In step 606, the catalog of translated documents is filtered based on the inferred preferred language, such that only translated documents in the preferred language are served to the user or presented in the catalog. In an alternate embodiment, step 606 may comprise retrieving and presenting a version of a web page that is in the preferred language (i.e., such that not only the listing of content is impacted by the preferred language but so is the entirety of the content of the webpage).

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise. Following are just some examples of alternate embodiments which are within the scope of the invention(s) described herein.

For example, in an alternate embodiment the translation service may support new language development. In some embodiments, this may entail a user of the translation service setting up a new language that the system supports. For example, templates may be provided so that wiki-style translation of new consumer, translator and publisher facing interfaces can be performed. Once the new interfaces are developed (either by the community or by system administrators) the translation process can begin for the newly developed language.

In accordance with some embodiments, a goal of the translation service may be to allow anyone to upload a published work that they have the copyrights to and allow the translation of that work into any language in the hope to maximize the proliferation, and market reach, of their product.

The following are some examples of additional functionality that may be implemented by the translation service:
(i) allow multiple translators to work on the same document (useful in long published works such as novels);
(ii) allow someone to become a translator without having to know a specified default language;
(iii) more flexible royalty structures;
(iv) the selection on a particular translator by a publisher for a particular job or translation;
(v) not utilizing a separate entity as a document distributor, which may means the translation service may be operable to: (a) convert translated documents to ePub, PDF, or other file formats; (b) synching with the API of retailers to ease the posting of translated documents; and/or (c) possible direct selling of translated documents from a website hosted or operated by or on behalf of the translation system (system as retailer);
(vi) subscription model for translated publications;
(vii) translation other than language translation (e.g., such as translation within the same language (e.g., English) but from more difficult-to-understand or specialized terminology to less-difficult-to-understand or specialized terminology (e.g., turn a research report or complex legal document into a middle school reading level version).

In accordance with some embodiments, the translation service may be used to create multimedia translations as well (e.g., translations of audio readings, animations, illustration etc.) and/or to support social functions, such as comments or reviews posted on news or social media sites, discussion boards, etc.

### Rules of Interpretation

The present disclosure is neither a literal description of all embodiments nor a listing of features of the invention that must be present in all embodiments.

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present disclosure” and the like mean “one or more embodiments of the present disclosure.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present disclosure(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired. Some displays may be interactive and may include touch screen features or associated keypads as is well understood.

A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present disclosure.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

What is claimed is:

1. A system for facilitating the translation of content from a first language to a second language, the system comprising:
a processor; and
a memory storing a program;
the processor being operable with the program to perform a method, the method comprising:
receiving a document consisting of a first area including a first set of text and a second area including a second set of text, the first area and the second area being positioned relative to one another in a particular layout;
identifying, in a second area of the plurality of areas, a second set of text which requires translation;
outputting in a first element of an online interface and to a first translator the first set of text for translation out of a context of the document;
outputting in a second element of the online interface and to a second translator the second set of text for translation out of the context of the document;
receiving in a third element of the online interface and from the first translator a first translated set of text corresponding to the first set of text;
receiving in a fourth element of the online interface and from the second translator a second translated set of text corresponding to the second set of text; and
creating a translated version of the document by positioning the first translated set of text and the second translated set of text relative to one another in essentially the particular layout, thereby essentially preserving a visual appearance of the document in the translated document without requiring either the first translator or the second translator to work on preserving the visual appearance when translating the first set of text and the second set of text, respectively.

2. The system of claim 1, wherein the first translator is the second translator.

3. The system of claim 2, wherein the first element is the second element and the third element is the fourth element.

4. The system of claim 1, wherein the processor is further operable with the program to:
output to the second translator the second set of text after determining that the first translated set of text has been received.

5. The system of claim 1, wherein the processor is further operable with the program to:
output, in a fifth element of the online interface and to the first translator and the second translator, the document, such that the first translator and the second translator may view in context the first set of text and the second set of text for which translation is being requested.

6. The system of claim 1, wherein the document includes at least one visual component positioned in the particular layout and wherein creating further comprises preserving a placement of the at least one visual component in the particular layout.

7. The system of claim 6, wherein the at least one visual component comprises at least one of an image, a drawing, an equation, a formula, a video, a graph, a chart and a window to external content.

8. The system of claim 1, wherein the processor being operable with the program to create a translated version of the document comprises the processor being operable with the program to select a font style and font size for the first translated set of text and the second translated set of text such that it appears essentially similar to the first set of text and the second set of text, respectively.

9. The system of claim 1, wherein the processor is further operable with the program to receive the document in a first file format and resave it to a second file format from which the first set of text and the second set of text may be extracted for translation.

10. A non-transitory computer-readable medium storing instructions for directing a processor to perform a method, the method comprising:
receiving a document consisting of a first area including a first set of text and a second area including a second set of text, the first area and the second area being positioned relative to one another in a particular layout;
identifying, in a second area of the plurality of areas, a second set of text which requires translation;
outputting in a first element of an online interface and to a first translator the first set of text for translation;
outputting in a second element of the online interface and to a second translator the second set of text for translation;
receiving in a third element of the online interface and from the first translator a first translated set of text corresponding to the first set of text;
receiving in a fourth element of the online interface and from the second translator a second translated set of text corresponding to the second set of text; and
creating a translated version of the document by positioning the first translated set of text and the second translated set of text relative to one another in essentially the particular layout, thereby essentially preserving a visual appearance of the document in the translated document without requiring either the first translator or the second translator to work on preserving the visual appearance when translating the first set of text and the second set of text, respectively.

11. A system for facilitating presentation of information via a website, the system comprising:
a memory storing a program; and
a processor, the processor being operable with the program to:
determine a request from a computing device to view information on a specified web page;
determine a preferred language of a user associated with the computing device, wherein the preferred language is automatically determined on behalf of the user based on information associated with the user and not based on a direct indication of the preferred language from the user; and
output information on the web page in the language.

12. The system of claim 11, wherein the processor being operable with the program to determine a preferred language of the user comprises the processor being operable with the program to:
determine an IP address of the computing device; and
determine a language corresponding to the IP address.

13. The system of claim 11, wherein the processor being operable with the program to determine a preferred language of the user comprises the processor being operable with the program to:
determine at least one cookie stored on the computing device, the cookie identifying a website previously visited by the computing device; and
determining a language of the website.

14. The system of claim 11, wherein the web page is associated with multiple documents which may be displayed via the web page and wherein the processor being operable with the program to output information in the language comprises determining which documents are in the language and outputting only the documents which are in the language.

15. The system of claim 11, wherein the processor is further operable with the program to output to a user associated with the computing device options for other language in which information may be output on the web page.

16. A non-transitory computer-readable medium storing instructions for directing a processor to perform a method, the method comprising:
determining a request from a computing device to view information on a specified web page;
determining a preferred language of a user associated with the computing device, wherein the preferred language is automatically determined on behalf of the user based on information associated with the user and not based on a direct indication of the preferred language from the user; and
outputting information on the web page in the language.
